(19) United States
(12) Patent Application Publication
(10) Pub. No.: US 2023/0258426 A1
(43) Pub. Date: Aug. 17, 2023

(54) DEVICE FOR MOUNTING A BARRELED WEAPON

(71) Applicant: SUSANNA DORATHEA JANSEN, Hermanus (ZA)

(72) Inventor: JACOBUS MARTHINUS JOHANNES, Hermanus (ZA)

(21) Appl. No.: 17/743,728

(22) Filed: May 13, 2022

(30) Foreign Application Priority Data
Feb. 17, 2022 (ZA) 2022/02007

(51) Int. Cl. F41A 23/18; A47B 81/00; B60R 7/14

(52) U.S. Cl. CPC F41A 23/18; A47B 81/005; B60R 7/14

(57) ABSTRACT

A device for mounting a barreled weapon is provided. The device includes one or more of the following: a base; a mounting bracket, being operable to extend laterally from a middle of the base, in use; an operatively upper end and an operatively lower end of the mounting bracket define openings therebetween, the openings being operable to receive mounting screws therein, to firmly secure the device to a flat surface, in use. The device may further include two or more guiding ribs, projecting from the base of the device, operable to receive at least a portion of the barreled weapon along an end thereof, such that the barreled weapon rests or is secured within the device, in use.

### FIELD OF THE INVENTION

This invention relates to a device for mounting a barreled weapon.

### BACKGROUND TO THE INVENTION

A firearm mount is defined as an assembly or mechanism used to hold a weapon (typically a gun) onto a platform in order for it to function at maximum capacity. Firearm mounts have a variety of purposes including display, security from theft, and prevention of unauthorized access and use.

Because firearms are expensive, and potentially harmful when in the wrong hands, many mechanisms have been proposed over the years for securing guns or otherwise limiting unauthorized access thereto. Many different mechanisms are currently available, e.g., gun safes, electronic gun safety systems and magnetic gun mounts. Generally, the specific requirements for the storage, transport and carrying of firearms are set out in legislation. For example, during the storage of a firearm, it must be unloaded, not readily accessible to unauthorized use, and securely attached with a secure locking device to a non-portable structure in such a manner that it cannot readily be removed.

It will be appreciated by those in the industry, that the safe and legally compliant storage of firearms which allows for easy access during an emergency, is a problem. For instance, many individuals find that they would like to have access to their firearm, for example when in a vehicle, but that there are very few options of where to store the firearm safely. With reference to a vehicle, an individual may store the firearm in the glove compartment, but such location is not very convenient if the individual wants to retrieve the firearm quickly, i.e., it is not within easy reach. Other possible storage locations in a vehicle include laying the firearm on/under or around the seating areas. Such locations are also inadequate as the firearm is either easily dislodged in the case of quick acceleration/deceleration (i.e., accidents), or it is not within easy reach of the individual.

Law enforcement personnel also often carry firearms in their vehicles. These weapons are often stored in a gun lock fastened securely to a gun rack. The gun rack is mounted either horizontally or vertically at an interior location in the vehicle and is generally mounted substantially parallel to a flat mounting base in the vehicle, such as the floor, a sidewall, or the ceiling. The design of a proper gun rack or mount for law enforcement use should provide for immediate release of the weapon when needed.

It will be further appreciated by those in the industry, that storage of such weapons in the home also presents problems. The weapon must be secure but readily available when needed. Similarly, it would be desirable to mount a gun for storage of firearms in homes or other buildings that allows for easy access during an emergency. While there are any number of means of storing firearms indoors such as gun safes, gun racks, and even personal holsters, it can be difficult to access and retrieve the firearm quickly when a potential emergency is anticipated. Furthermore, even after retrieving the firearm from these other storage areas, there remains a need to load a round in the chamber before the firearm can be used.

An example of a weapon which requires secure storage and easy access is a personal handheld security device. A typical example would be the Byrna™, which is a handheld projectile launcher that is provided in the form of a firearm. The Byrna™ is a CO2 powered weapon capable of launching up to 68 chemical irritant rounds which are filled with a highly potent cocktail of oleoresin capsicum (also known as QC or “pepper spray”), a lachrymator agent (also known as “tear gas” or), and pelargonic acid vanillylamide (also known as PAVA or “synthetic pepper spray”).

It will be appreciated, that the Byrna™ device requires no firearm license to purchase or carry, and there are no waiting periods or background checks required to purchase and own such a device. As such, the general legislative requirements for the safe storage, transport and carrying of firearms would not be applicable to such a device. However, it is widely known in the industry that a handheld security device such as the Byrna™ is an all-polymer device. As such, traditional magnet-style mounts will not be effective for the mounting of such a weapon. In these respects, a fixable firearm mount for the Byrna™ would need to substantially depart from the conventional concept and designs of prior art weapon mounts.

Consequently, it will be appreciated by those skilled in the art that there exists a long-felt need for weapon mount for the safe storage and transportation of an all-polymer weapon such as a Byrna™ which will allow easy accessibility, while still ensuring that the weapon remains safe and secure, and protected from damage.

Consequently, it will be appreciated by those skilled in the art that there exists a long-felt need for a mount that will allow for the mounting of a to any horizontal or vertical flat surface in a vehicle or building.

### SUMMARY OF THE INVENTION

It is an object of the invention to provide a device for mounting a barreled weapon which provides the advantages and addresses some of the issues and deficiencies described above.

According to a first aspect of the invention, there is provided a device for mounting a barreled weapon, said device including one or more of the following:

a base;

a mounting bracket, the mounting bracket being operable to extend laterally from the middle of the base, in use; wherein an operatively upper end and an operatively lower end of the mounting bracket define an opening therebetween, said opening being operable to receive mounting screws therein, to firmly secure said device to a flat surface, in use.

In an embodiment of the invention, said device includes two or more guiding ribs, projecting from the base of the device, operable to receive at least a portion of the barreled weapon along an end thereof, such that the barreled weapon rests or is secured within said device, in use.

In an embodiment of the invention, the guiding ribs act are operable to guide the placement of the barreled weapon within the mounting bracket, in use. In preferred embodiments, the operatively upper portions of the guiding ribs are angled to guide the barreled weapon when the barreled weapon is being mounted.

In an embodiment of the invention, said device further includes a muzzle housing on the base. In this embodiment, said muzzle housing is sized and configured (i.e., structured and arranged) to accommodate the muzzle end of the barreled weapon, in use.

In an embodiment of the invention, the base includes a screw boss operable to affix the muzzle end of the barreled weapon to the device, in use.

In an example embodiment of the invention, said device is manufactured using a plastic injection molding process.

In an embodiment of the invention, said device is manufactured from a lightweight (gram per cubic meter) and/or durable and/or cost-effective material.

### BRIEF DESCRIPTION OF THE DRAWINGS

These and other features of this invention will become apparent from the following description of one example described with reference to the accompanying drawings in which:

FIG. 1 shows a top diagrammatic view of a firearm mounting device, in accordance with an embodiment of the invention;

FIG. 2 shows an anterior diagrammatic view of a firearm mounting device, in accordance with an embodiment of the invention;

FIG. 3 shows a bottom diagrammatic view of a firearm mounting device, in accordance with an embodiment of the invention;

FIG. 4 shows a side diagrammatic view of a firearm mounting device, in accordance with an embodiment of the invention;

FIG. 5 shows an anterior diagrammatic view of a firearm mounting device, in accordance with an embodiment of the invention;

FIG. 6 shows a bottom diagrammatic view of a firearm mounting device, in use, in accordance with an embodiment of the invention; and

FIG. 7 shows a side diagrammatic view of a firearm mounting device, in use, in accordance with an embodiment of the invention.

### DETAILED DESCRIPTION OF THE EMBODIMENT

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilizing other features. Accordingly, those skilled in the art will recognize that modifications and adaptions to the present invention are possible and can even be desirable in certain circumstances and are a part of the present invention. Thus, the following description is provided as illustrative of the principles of the present invention and limitation thereof.

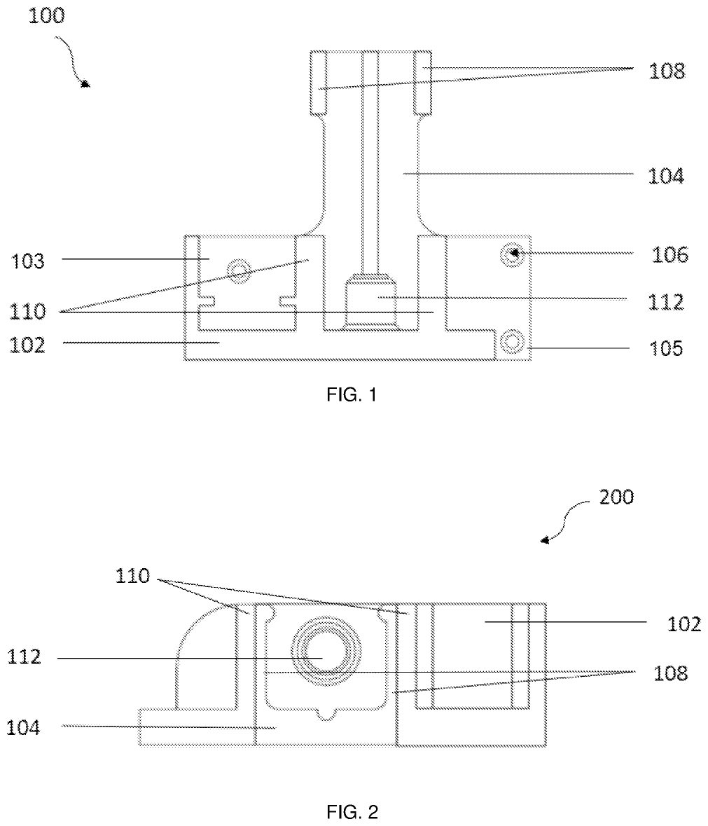

With reference to FIG. 1, a firearm mounting device is generally described with reference to numeral 100.

The device 100 includes a flat base 102. The device 100 further includes a mounting bracket 104. The mounting bracket 104 extends perpendicularly upward from the base 102. The mounting bracket 104 defines two openings 106 positioned in the mounting bracket 104 to allow the device 100 to be versatile in use in a vehicle or building where a screw or nail can be extended through the openings 106 into a vertical or horizontal surface to keep it in place and secure the device 100.

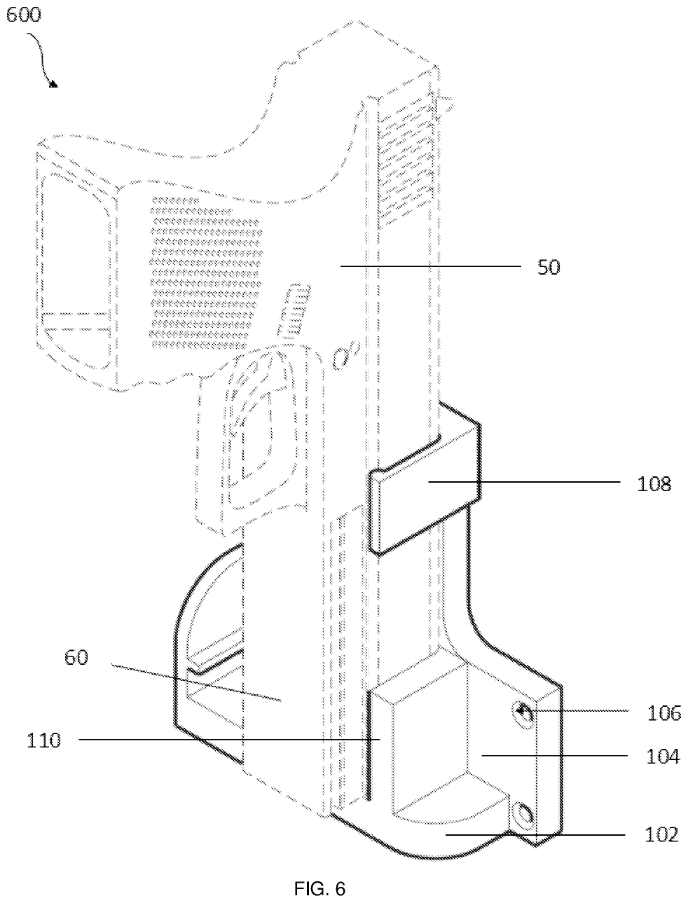

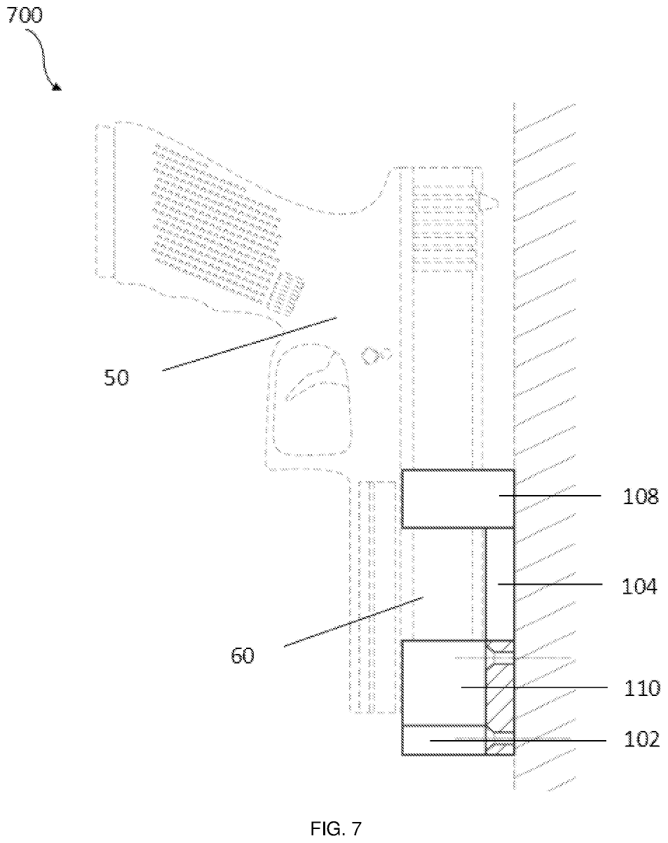

The device 100 further includes guiding ribs 108 to act as guides for mounting a firearm 50 (see FIGS. 6 and 7) in place. The inside surfaces of the top portions of the guiding ribs 108 are angled outward to act as a guide when the firearm 50 is being mounted.

The device 100 device further includes a muzzle housing 110 on the base 102, which is sized and configured to accommodate the muzzle end 60 (see FIGS. 6 and 7) of the firearm 50. The base 102 further includes a screw boss 112 operable to insert into and fixing with the muzzle end 60 of the firearm 50, in use.

With reference to FIG. 2, a firearm mounting device is generally described with reference to numeral 200.

Please note that with reference to FIG. 2, the same reference numerals (e.g., 102, 104 etc.) will be used to describe the same aspects as described with reference to FIG. 1.

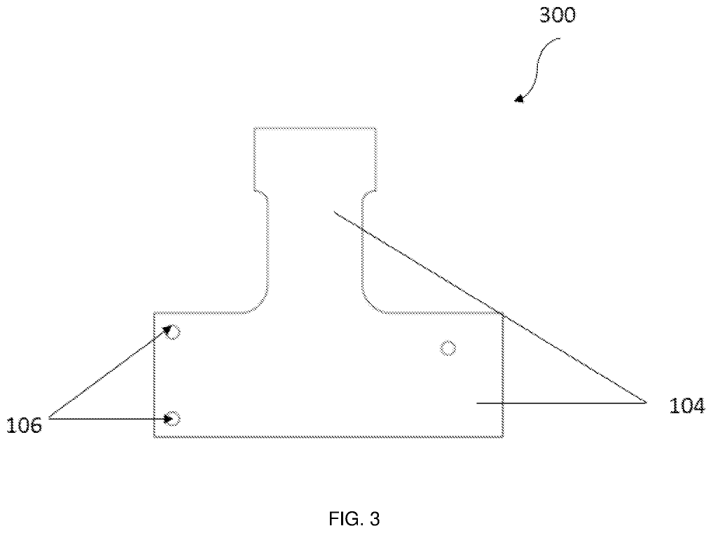

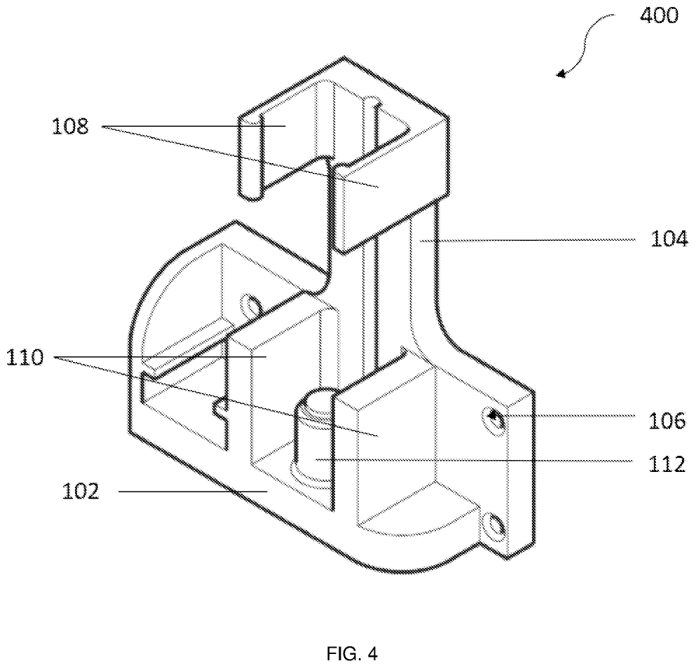

With reference to FIG. 3, a firearm mounting device, is generally described with reference to numeral 300.

Please note that with reference to FIG. 3, the same reference numerals (e.g., 102, 104 etc.) will be used to describe the same aspects as described with reference to FIG. 1.

With reference to FIG. 4, a firearm mounting device, is generally described with reference to numeral 400.

Please note that with reference to FIG. 4, the same reference numerals (e.g., 102, 104 etc.) will be used to describe the same aspects as described with reference to FIG. 1.

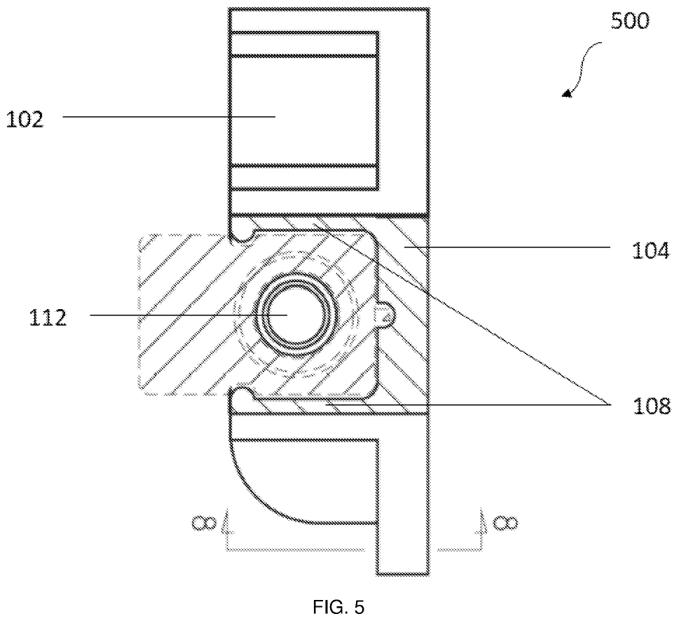

With reference to FIG. 5, a firearm mounting device, is generally described with reference to numeral 500.

Please note that with reference to FIG. 5, the same reference numerals (e.g., 102, 104 etc.) will be used to describe the same aspects as described with reference to FIG. 1.

With reference to FIG. 6, a firearm mounting device, in use, is generally described with reference to numeral 600.

Please note that with reference to FIG. 6, the same reference numerals (e.g., 102, 104 etc.) will be used to describe the same aspects as described with reference to FIG. 1.

With reference to FIG. 7, a firearm mounting device, in use, is generally described with reference to numeral 700.

Please note that with reference to FIG. 7, the same reference numerals (e.g., 102, 104 etc.) will be used to describe the same aspects as described with reference to FIG. 1.

1. A device for mounting a barreled weapon (50), said device comprising:
a base (102);
a muzzle housing (110) on said base (102), said muzzle housing (110) being sized and configured to accommodate a muzzle end (60) of said barreled weapon (50); and
a mounting bracket (104), the mounting bracket being operable to extend laterally from a middle of the base, in use;
wherein an operatively upper end (103) and an operatively lower end (105) of the mounting bracket define openings (106) therebetween, said openings (106) being operable to firmly secure said device to a flat surface, in use; and
wherein said base (102) comprises a screw boss (112) operable to affix a muzzle end (60) of said barreled weapon (50) to said device, in use.

2. The device for mounting a barreled weapon as claimed in claim 1, wherein said device comprises two or more guiding ribs (108), projecting from the base (102) of said device, operable to receive at least a portion of the barreled weapon (50) along an end thereof, such that said barreled weapon (50) rests or is secured within said device, in use.

3. The device for mounting a barreled weapon as claimed in claim 2, wherein said guiding ribs (108) are operable to guide a placement of said barreled weapon (50) within said mounting bracket (104), in use.

4. The device for mounting a barreled weapon as claimed in claim 3, wherein inside surfaces of upper portions of said guiding ribs (108) are angled outward to guide said barreled weapon (50) when said barreled weapon (50) is being mounted into said device from above.

5. (canceled)

6. (canceled)

7. The device for mounting a barreled weapon as claimed in claim 1, wherein said device is manufactured using a plastic injection molding process.

8. A device for mounting a barreled weapon, comprising:
a base (102); and
a mounting bracket (104), extending perpendicularly upward from the base (102) and defining a plurality of openings (106) at an end close to the base (102), wherein the openings
(106) are configured to receive mounting screws therein to firmly secure the device to a target surface;
guiding ribs (108), disposed on another end of the mounting bracket (104) far away from the base (102);
a muzzle housing (110), disposed on the base (102) and configured to accommodate a muzzle end (60) of the barreled weapon (50); and
a boss (112), disposed on the base (102) and in the muzzle housing (110) and configured to be inserted into and fix with the muzzle end (60) of the barreled weapon (50).

9. The device as claimed in claim 8, wherein the guide ribs (108) and the muzzle housing (110) are located on the same side of the mounting bracket (104).
